(19) United States
(12) Patent Application Publication
(10) Pub. No.: US 2024/0016229 A1
(43) Pub. Date: Jan. 18, 2024

(54) Aerosol Generating Device Authenticated by Signal

(71) Applicant: EM-TECH Co., Ltd., Gyeongsangnam-do (KR)

(72) Inventors: Hyung Min Kim, Daegu (KR); Sung Min Cho, Gyeonggi-do (KR); Se Won Park, Seoul (KR); Jong Hun You, Seoul (KR)

(21) Appl. No.: 18/222,042

(22) Filed: Jul. 14, 2023

(30) Foreign Application Priority Data
Jul. 15, 2022 (KR) 1020220087832

(51) Int. Cl. A24F 40/49; A24F 40/51; A24F 40/42; A24F 40/65

(52) U.S. Cl. CPC A24F 40/49; A24F 40/51; A24F 40/42; A24F 40/65; A24F 40/46

(57) ABSTRACT

Embodiments relate to an aerosol generating device authenticated by a signal, and more particularly, to an aerosol generating device which is unlocked upon receiving, through a certain signal, an authentication result of an age authentication, a region authentication, and a cartridge genuine product authentication which is performed by an external device.

### TECHNICAL FIELD

Embodiments relate to an aerosol generating device authenticated by a signal, and more particularly, to an aerosol generating device which is unlocked upon receiving, through a certain signal, an authentication result of an age authentication, a region authentication, and a cartridge genuine product authentication which is performed by an external device.

### BACKGROUND

Inhalation of preference substances, generally, such as smoking, may be achieved by inhaling microparticles, that is, an aerosol, in the air. In the past, cigarette-type cigarettes were almost the only means of inhaling such preference substances, but recently, aerosol generating devices, such as electronic cigarettes, have also been used together. Electronic cigarettes generate an aerosol by vaporizing an inhaled material into vapor by applying heat or ultrasonic waves to a cartridge in which the inhaled material is included in a liquid form, and thus, electronic cigarettes are significantly different from the conventional cigarette-type cigarettes that generate smoke by burning and have the advantages of preventing the occurrence of various harmful substances that may occur by combustion.

Due to the possibility of inhaling nicotine, aerosol generating devices are subject to regulations, such as restrictions on sale or use, like regular cigarettes. Nevertheless, it is possible for teenagers to easily acquire and use aerosol generating devices through proxy purchase and used trading, and problems of unauthorized use by family members may occur. In addition, aerosol generating devices may have to be restricted in the region of use due to a regional influence of the law.

Korean Patent No. 10-2222248 discloses an electronic cigarette user authentication system and method. Also, Korean Patent No. 10-2325372 discloses a method of authenticating a user through an external device and determining an operation of an aerosol generating device according to an authentication result. Korea Application Publication No. 10-2021-0080943 discloses a means for enabling only users who have acquired user authentication to use an aerosol generating device by adding a biometric authentication function to the aerosol generating device.

Since these related art methods may still avoid age restriction authentication or user authentication, it is necessary to prevent authentication bypass, which is a limitation of the related arts, by using an authorized authentication system. When the aerosol generating devices have a biometric authentication function, it is possible to initialize the devices and re-register biometric information for use, and thus, it may be difficult to prevent teenagers from using aerosol generating devices. In addition, authenticating aerosol generating devices by an external device is intended to provide additional functions to users, and in this case, aerosol generating devices may be used without authentication.

### SUMMARY

An aspect of the present disclosure is to provide an aerosol generating device, for which an age, a region, and whether a cartridge is a genuine product are authenticated in conjunction with an authentication system, when intended to be used, and which may be unlocked only when authenticated, thereby preventing cheating on the aerosol generating device.

Another aspect of the present disclosure is to provide an aerosol generating device which may be unlocked by receiving an unlock signal according to successful authentication through a simple configuration without a separate communication module.

According to an aspect of the present disclosure, an aerosol generating device switchable to a locked state and unlocked state includes: a power supply applying power to a component; an aerosol generating unit operating in the unlocked state, allowing a cartridge, which is a consumable, to be mounted therein, and including a heater; an authentication signal detecting unit detecting an authentication signal output from an external device; an authentication signal processing unit processing the detected authentication signal; and a controller controlling an operation of the aerosol generating unit and switching a state into a locked state and an unlocked state, wherein the controller switches the state of the aerosol generating device from the locked state to the unlocked state according to the authentication signal detected by the authentication signal detecting unit.

Also, in an embodiment of the present disclosure, the authentication signal detected by the authentication signal detecting unit may include at least one of a cartridge genuine authentication signal, a region authentication signal, and an age authentication signal.

Also, in an embodiment of the present disclosure, when results of all authentications included in the authentication signal detected by the authentication signal detecting unit are normal, the controller may switch the state of the aerosol generating device from the locked state to the unlocked state.

Also, in an embodiment of the present disclosure, the authentication signal detected by the authentication signal detecting unit may be any one of electromagnetic waves, sound waves, vibrations, and optical signals.

Also, in an embodiment of the present disclosure, the authentication signal detected by the authentication signal detecting unit may include a control command for setting the aerosol generating unit to generate heat while following a predetermined heat generating mode.

Also, in an embodiment of the present disclosure, the authentication signal processing unit may modulate the detected authentication signal in one or more of pulse modulation methods so that the controller recognizes the authentication signal.

Also, in an embodiment of the present disclosure, the controller may switch the state of the aerosol generating device to the locked state when the cartridge mounted in the aerosol generating unit is removed in the unlocked state.

Also, in an embodiment of the present disclosure, the aerosol generating device may further include: a puff sensor detecting a user's puff action, wherein the controller calculates a number of puffs based on the user's puff action detected by the puff sensor, and when the calculated number of puffs exceeds a predetermined threshold, the controller switches the aerosol generating device to the locked state.

According to another aspect of the present disclosure, an authentication system of an aerosol generating device using a signal includes: an aerosol generating device according to any one embodiment and an authentication providing device including an authentication unit performing at least one of genuine authentication of the cartridge mounted in the aerosol generating device, authentication of the user's region, and authentication of the user's age, an authentication signal generating unit generating an authentication signal based on an authentication result of the authentication unit, and authentication signal output unit outputting the generated authentication signal to the outside.

Also, in an embodiment of the present disclosure, the authentication signal generating unit may modulate the authentication signal to be output by one or more of the pulse modulation methods so that the aerosol generating device recognizes the authentication signal.

Also, in an embodiment of the present disclosure, the authentication unit may perform genuine authentication by recognizing a OR code of the cartridge mounted in the aerosol generating device.

Also, in an embodiment of the present disclosure, the authentication signal generated by the authentication signal generating unit may include a control command for setting the aerosol generating unit to generate heat while following a predetermined heat generating mode.

Also, in an embodiment of the present disclosure, the authentication signal output by the authentication signal output unit may be any one of electromagnetic waves, sound waves, vibrations, and optical signals.

As described above, since an age, a region, and whether a cartridge is a genuine product have to be authenticated to unlock the aerosol generating device according to the present disclosure, unauthorized use of the aerosol generating device may be prevented.

In addition, since the aerosol generating device according to the present disclosure is authenticated by an external device, reliable authentication may be performed.

In addition, since the aerosol generating device according to the present disclosure may transmit a normal authentication signal through wireless signal transmission that does not require a communication module, the configuration is simple and the product costs may be reduced.

### BRIEF DESCRIPTION OF THE DRAWINGS

FIG. 1 is a block diagram illustrating a functional configuration of an aerosol generating device according to an embodiment of the present disclosure;

FIG. 2 is a configuration diagram of an authentication system including an aerosol generating device according to an embodiment of the present disclosure;

FIG. 3 is a block diagram of an authentication providing device;

FIG. 4 is a flowchart illustrating an operating method that may be performed by an aerosol generating device according to an embodiment of the present disclosure; and

FIG. 5 is a flowchart illustrating an unlocking process that may be performed by an aerosol generating device according to an embodiment of the present disclosure.

### DETAILED DESCRIPTION

Hereinafter, the present disclosure will be described in more detail with reference to the drawings.

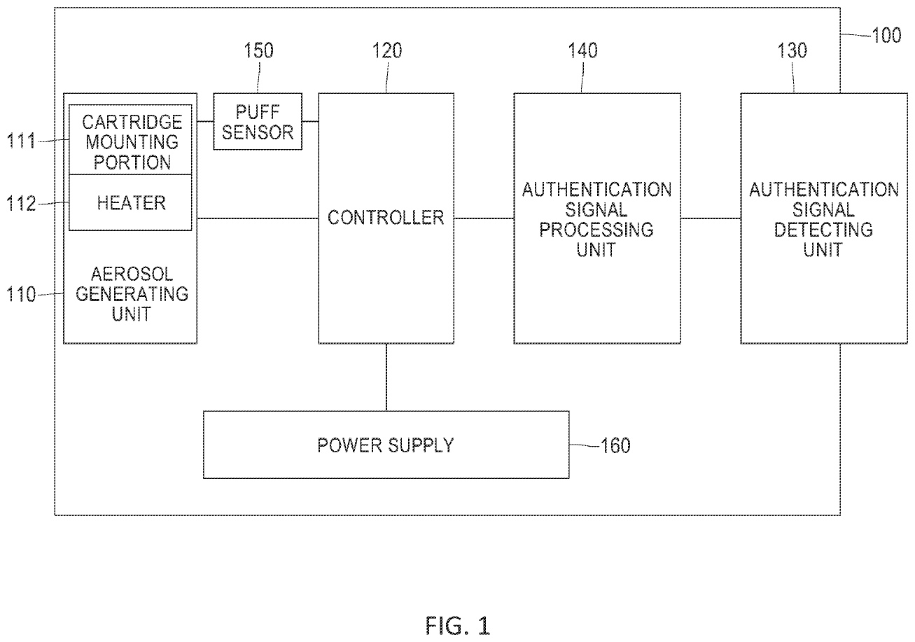

FIG. 1 is a block diagram illustrating a functional configuration of an aerosol generating device according to an embodiment of the present disclosure. In the present embodiment, the aerosol generating device 100 may include an aerosol generating unit 110, a controller 120, an authentication signal detecting unit 130, an authentication signal processing unit 140, and a power supply 160. The aerosol generating device 100 may be maintained in any one of a locked state and an unlocked state by the controller 120. The locked state may be switched to an unlocked state through an authentication process to be described below, in which, for example, an operation of the aerosol generating unit 110 may be restricted. In particular, it is preferred that the controller 120 allows the aerosol generating unit 110 to operate only when the aerosol generating device is unlocked. It is also preferred that the aerosol generating device 100 is initially manufactured in a locked state.

The aerosol generating unit 110 is an element that generates an aerosol by heating a mounted cartridge so that the user may inhale the aerosol. The aerosol generating unit 110 may include a cartridge mounting portion 111 into which a cartridge (not shown), which is a consumable containing liquid to be converted into an aerosol, and a heater supplying energy to the cartridge mounting portion 111 or the cartridge by a method, such as resistance heating, induction heating, high frequency heating, or the like to generate an aerosol. The aerosol generating unit 110 corresponds to a technology that is easily recognized by those skilled in the art to which the present disclosure pertains, and thus a detailed description thereof will be omitted. The power supply 160 may be, for example, a secondary battery, and apply power required for an operation to all or some of the components, such as the aerosol generating unit 110, the controller 120, the authentication signal detecting unit 130, and the authentication signal processing unit 140.

The controller 120 may include, for example, a micro-controller unit (MCU) capable of performing command processing, various operations, and device control. The controller 120 controls the operation of the aerosol generating unit 110 and performs state switching to one of a locked state and an unlocked state of the aerosol generating device 100. In addition, the controller 120 switches the state of the aerosol generating device 100 in a locked state into an unlocked state according to an authentication signal detected and processed by the authentication signal detecting unit 130 and the authentication signal processing unit 140, so that a user may use the aerosol generating device 100.

The authentication signal detecting unit 130, a unit for detecting an authentication signal output from an external device (i.e., an authentication providing device to be described below), may include, for example, any one or more of an antenna for detecting electromagnetic waves output from an external device, a microphone for detecting sound waves output from an external device, a 3-axis acceleration sensor for detecting vibration output from an external device, or an illuminance sensor for detecting an optical signal output from an external device. According to embodiments, the authentication signal detecting unit 130 may perform pre-processing, such as converting the detected authentication signal into a digital signal. Preferably, the authentication signal detecting unit 130 detects an authentication signal received at a short distance, without passing through a wired connection. Accordingly, the aerosol generating device 100 may receive the authentication result through the authentication signal detecting unit 130 without a wireless communication module or wired connection terminal of the related art.

The authentication signal processing unit 140 may include, for example, a digital signal processor (DSP) to perform operations, such as signal modulation and demodulation, coding and decoding, and the like. The authentication signal processing unit 140 may perform various signal processing to translate the authentication signal detected by the authentication signal detecting unit 130. For example, when the authentication signal detected by the authentication signal detecting unit 130 is an analog signal, the authentication signal processing unit 140 may convert the analog signal into a digital signal to easily process the analog signal. Alternatively, the authentication signal processing unit 140 may classify and convert an authentication signal detected as a signal that can be recognized by the controller 120. In particular, the authentication signal processing unit 140 may modulate the authentication signal using a pulse modulation method, for example, a pulse-density modulation (PDM) method or a pulse-code modulation (PCM) method so that the controller 120 may recognize the authentication signal. For example, when the authentication signal detecting unit 130 detects a sound wave through a digital microphone, the sound wave is collected as 1-bit PDM data, and for signal analysis in the authentication signal processing unit 140 or the controller 120, the 1-bit PDM data may be modulated into PCM data using a sigma-delta A/D converter. Also, according to an embodiment, the authentication signal processing unit 140 or the controller 120 may convert the authentication signal modulated by the PCM method by fast Fourier transform (FFT) in order to analyze the authentication signal in the frequency domain.

The digitization, modulation, and conversion of data described above may be performed by the controller 120 or the authentication signal processing unit 140 by dividing roles as necessary, and according to design requirements, the controller 120 and the authentication signal processing unit 140 may be a single component that is substantially the same. Alternatively, the authentication signal processing unit 140 may be included as part of the controller 120 according to design requirements. As the degree of integration of semiconductors has increased, the above components may be separated or integrated without physical limitations.

The authentication signal may be determined as an authentication result and a control command by the authentication signal processing unit 140, and also, finally, by the controller 120 through signal-specific factors, such as signal duration, number of repetitions, frequency, timing, signal strength, etc. The authentication signal may be translated according to a predetermined decoding rule, such as Morse code. For example, an external device that outputs the authentication signal and the aerosol generating device 100 may share the method of generating and translating the authentication signal from the manufacturing stage.

In addition, in order to prepare for the possibility of copying and using the authentication signal output by an external device, the external device and the aerosol generating device 100 may share an encryption method and a decryption method thereof to convert the authentication signal into a random number or decode the same into a signal that may be translated. For example, when the external device generates a random number based on a seed, an encryption algorithm, and a current date or time shared with the aerosol generating device 100, the authentication signal detecting unit 130 may decode the random number based on the shared seed, the encryption algorithm, and the current date or time at which the authentication signal is detected. Through this method, the authentication signal may be transmitted and received by the encryption method.

As such, a method for the authentication signal processing unit 140 or the controller 120 to translate the authentication signal output from the external device may be implemented by various methods that are not particularly limited, as long as there is a prior agreement therebetween. For example, the authentication signal may be translated using a Morse code rule or a conventional string encoding method, such as ASCII code, UTF-8, or UTF-16.

The authentication signal detected by the authentication signal detecting unit 130 may include any one or more of a cartridge genuine authentication signal, a region authentication signal, or an age authentication signal. In addition, the authentication signal may include a control command indicating how the controller 120 controls the aerosol generating unit 110. In this case, the controller 120 may control the aerosol generating unit 110 to generate heat while following a predetermined heat generating mode according to the included control command.

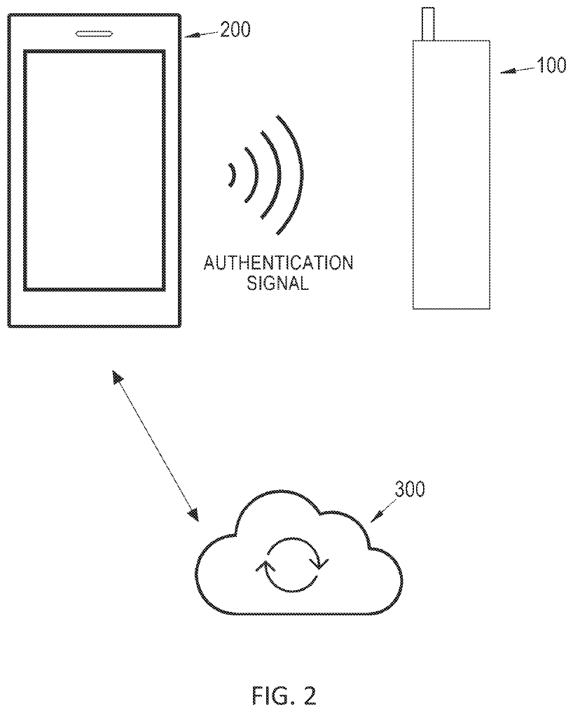

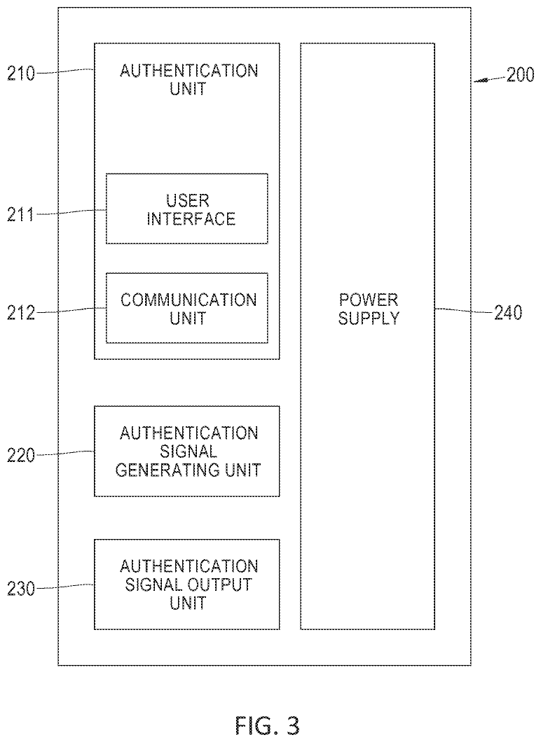

FIG. 2 is a configuration diagram of an authentication system including the aerosol generating device 100 according to an embodiment of the present disclosure, and FIG. 3 is a block diagram of an authentication providing device 200. In the present embodiment, the authentication system of an aerosol generating device may include the aerosol generating device 100 of any one embodiment of the present disclosure and the authentication providing device 200 performing predetermined authentication through interaction with the authorized authentication system 300 and outputting a corresponding result as an authentication signal. The authentication providing device 200 receives various authentication results performed by the authorized authentication system 300 as an input, and generates and outputs an authentication signal in a form that the aerosol generating device 100 may translate based on the input.

The authentication providing device 200 may include an authentication unit 210 performing at least one of authentication of the cartridge mounted in the aerosol generating device 100, authentication of the user's region, and authentication of the user's age through interaction with the authorized authentication system 300, an authentication signal generating unit 220 generating an authentication signal based on an authentication result from the authentication unit 210, and an authentication signal output unit 230 outputting the generated authentication signal to the outside.

The authentication providing device 200 may be, for example, a terminal device, such as a PC, a smartphone, or tablet of the related art, except that the authentication providing device 200 performs a process specific to the embodiments of the present disclosure. The authentication providing device 200 may be a terminal device that is connected to the authorized authentication system 300 through the internet, requests genuine authentication of the cartridge, authentication of the user's region, and authentication of the user's age, and receives a corresponding authentication result. Referring to FIG. 3 for illustrative purposes, the authentication unit 210 of the authentication providing device 200 may include a user interface 211 allowing the user to input information for various types of authentication and to interact with the authentication providing device 200 and a communication unit 212 for connecting the authorized authentication system 300 and the authentication providing device 200 over the Internet. The authentication signal generating unit 220 generates an authentication signal including an authentication result of the authentication unit 210, for example, a result of genuine authentication of the cartridge mounted in the aerosol generating device 100, a result of authentication of the user's region, and a result of authentication of the user's age, so that the aerosol generating device 100 may detect and translate the authentication signal. As described above, when generating the authentication signal, the signal may be processed using encoding or decoding rules shared with the aerosol generating device 100 or signal modulation and demodulation rules. For example, the authentication signal generating unit 220 may modulate the authentication signal to be output in a manner of pulse modulation, for example, pulse-density modulation (PDM) or pulse-code modulation (PCM), so that the aerosol generating device 100 may recognize the authentication signal.

The authentication unit 210 and the authentication signal generating unit 220 may be physically a single component according to an embodiment, and may be, for example, a microprocessor performing various command processing and calculations and also enabling various applications to be executed. In addition, the authentication providing device 200 may include a power supply 240 supplying power to the above components. The authentication unit 210 may also include a camera (not shown) to perform genuine authentication by recognizing a QR code displayed on the cartridge mounted in the aerosol generating device 100, and in this process, the authentication unit 210 may perform authentication by performing communication with the authorized authentication system 300 described above.

The authentication signal generated by the authentication signal generating unit 220 may include a control command for controlling the aerosol generating device 100, which is to receive the authentication signal, as well as various authentication results described above. For example, the authentication unit 210 may recognize the OR code displayed on the cartridge mounted in the aerosol generating device 100 to perform genuine authentication, determine a heat generating mode appropriate for the corresponding cartridge based on information included in the OR code to follow the heat generating mode, and include a control command for causing the aerosol generating unit 110 to generate heat in the authentication signal generated by the authentication signal generating unit 220 so that optimal heating control may be performed automatically.

The authentication signal output unit 230 may convert the authentication signal generated by the authentication signal generating unit 220 into, for example, any one of electromagnetic waves, sound waves, vibrations, or optical signals, and output the same, and the authentication signal detecting unit 130 of the aerosol generating device 100 in a short distance may detect the same. Therefore, the authentication signal output unit 230 may include an antenna outputting electromagnetic waves, a speaker outputting sound waves, a vibration module outputting vibrations, or a light source outputting optical signals, depending on the type of the output authentication signal. Accordingly, the authentication result may be transmitted to the aerosol generating device 100 through the authentication signal output unit 230, which is relatively inexpensive and may already be included in the authentication providing device 200 for other purposes. When the authentication signal is an electromagnetic wave, a sound wave, or an optical signal, the authentication providing device 200 may transmit the authentication signal to the aerosol generating device 100 located in a relatively short distance. Also, when the authentication signal is vibration, the authentication signal may be transmitted while the authentication providing device 200 and the aerosol generating device 100 are in contact with each other so that the vibration may be transmitted to each other.

The authorized authentication system 300 may include, for example, various identity authentication services that may be accessed through an application running on the authentication providing device 200, that may be provided by a credit information company, and that may be able to authenticate at least age. This identity authentication service may authenticate the date of birth, gender, and name through, for example, mobile phone authentication, PASS application authentication, co-certificate authentication, ID authentication, or authentication using an OTP generator, and transfer an authentication result again through an application of the authentication providing device 200 to authenticate at least age. In addition, the identity authentication services may include a cartridge genuine authentication service operated by the manufacturer of the aerosol generating device 100 and a region authentication service.

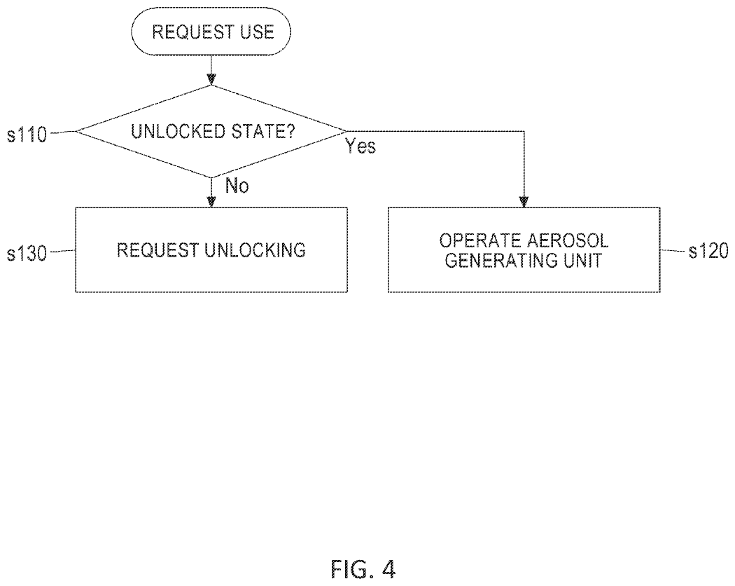

FIG. 4 is a flowchart illustrating an operating method that may be performed by the aerosol generating device 100 according to an embodiment of the present disclosure. In the present embodiment, upon receiving the user's request to use the aerosol generating device 100, the controller 120 determines whether a current state is an unlocked state or locked state (s110). The user's request for use may be regarded as a request for use, for example, an action, such as turning on power of the aerosol generating device 100 or pressing an operation button after turning the power on. When the controller 120 determines that the current state of the aerosol generating device 100 is the unlocked state, the controller 120 may operate the aerosol generating unit 110 in response to the use request (s120). Meanwhile, if the controller 120 determines that the current state of the aerosol generating device 100 is a locked state, the controller 120 may request the user to unlock the aerosol generating device 100, without operating the aerosol generating device 110 (s130). After step s130, the controller 120 may perform an unlocking process to be described in detail below.

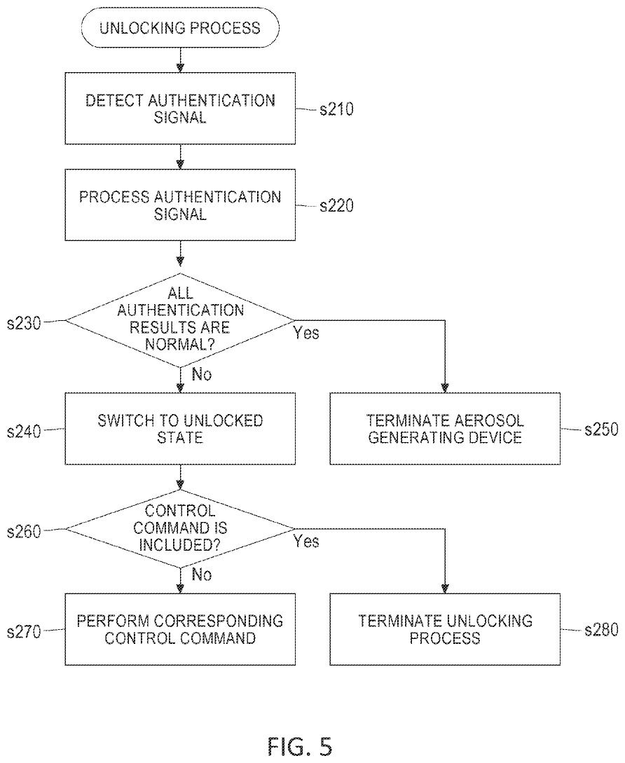

FIG. 5 is a flowchart illustrating an unlocking process that may be performed by the aerosol generating device 100 according to an embodiment of the present disclosure. First, the authentication signal detecting unit 130 continuously detects whether there is an authentication signal received from a short distance (s210). When a signal is detected by the authentication signal detecting unit 130, the authentication signal detecting unit 130 or the authentication signal processing unit 140 may determine whether the detected signal is an authentication signal. If the detected signal is determined not to be an authentication signal, step S210 may be repeated, and when the detected signal is determined to be an authentication signal, an authentication signal processing step (s220) may be performed. In this step, as described above with respect to the authentication signal processing unit 140, the authentication signal processing unit 140, or the authentication signal processing unit 140 together with the controller 120, may perform a data processing process, such as signal digitization, pulse modulation, and FFT conversion, so that the controller 120 may analyze or translate the authentication signal detected by the authentication signal detecting unit 130. Also, in this process, in order to convert the authentication signal into data including text, decoding may be performed using a predetermined decoding rule or decryption may be performed according to a predetermined rule.

Next, the controller 120 translates the authentication signal that has undergone the signal processing and decoding process described above, and determines whether all authentication results included are normal (s230). The authentication result being normal may refer to, for example, a signal indicating that cartridge genuine authentication performed by an external device, for example, the authentication providing device 200 of any embodiment of the present disclosure has been confirmed, a signal indicating that a region to be used currently is authenticated as an available region, and a signal indicating that the user's age is authenticated as an age at which the aerosol generating device 100 may be used. In this manner, when one or a plurality of authentication results included in the authentication signal are determined to be normal, the controller 120 converts the aerosol generating device 100 from a locked state to an unlocked state so that the user may be allowed to use the aerosol generating device 100 (s240). Meanwhile, when the controller 120 determines that any one of the authentication results included in the authentication signal is not normally authenticated in step s230, the aerosol generating device 100 may be terminated (s250). Accordingly, by releasing the locked state or by not releasing the locked state of the aerosol generating device 100 based on the result of determining whether the cartridge is genuine, the appropriateness of the region of use, and the appropriateness of the user's age, an unauthorized user may be prevented from using the aerosol generating device 100.

For example, the controller 120 may additionally determine whether a control command is included in the authentication signal (s260). In this step, if it is determined that a control command is included in the authentication signal, the controller 120 may perform control according to the included control command (s270). For example, as described above, when it is determined that a control command for setting the aerosol generating unit 110 to generate heat while following a predetermined heat generating mode is included, the controller 120 may control the aerosol generating unit 110 to generate heat while following the heat generating mode when the aerosol generating device is used. When it is determined in step s260 that the control command is not included in the authentication signal, the unlocking process may be terminated without additional control (s280).

According to embodiments, the aerosol generating device 100 of the present disclosure may switch the state from an unlocked state to a locked state by the controller 120 when a predetermined condition is met. For example, when the cartridge mounted in the aerosol generating unit 110 is removed while the aerosol generating device 100 is in an unlocked state, the aerosol generating device 100 may be switched to a locked state to perform genuine authentication on a newly installed cartridge. In addition, since region authentication or age authentication may be newly performed, the security of the aerosol generating device 100 may be further strengthened.

Alternatively, as shown in FIG. 1, the user's puff (inhalation) action is detected through a puff sensor 150 that may be included in the aerosol generating device 100 and the accumulated number of puffs may be calculated, and based thereon, the controller 120 may switch the aerosol generating device 100 to a locked state. The puff sensor 150 is a sensor capable of detecting a user's puff action, and is preferably, a pressure sensor installed near the aerosol generating unit 110. Due to user's puff action, pressure inside the aerosol generating unit 110 may temporarily decrease, and upon detecting such a change in the pressure, the puff sensor 150 may detect the user's puff action. For example, the controller 120 may calculate the number of puffs by accumulating the number of user's puff actions detected by the puff sensor 150 since the current cartridge is mounted, and when the calculated number of puffs exceeds a predetermined threshold, the controller 120 may determine that the currently installed cartridge is used up and switch the aerosol generating device 100 to a locked state. The number of puffs may be reset to zero when a new cartridge is installed.

As used herein, the terms “having,” “containing,” “including,” “comprising,” and the like are open-ended terms that indicate the presence of stated elements or features, but do not preclude additional elements or features. The articles “a,” “an” and “the” are intended to include the plural as well as the singular, unless the context clearly indicates otherwise.

It is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An aerosol generating device switchable to a locked state and an unlocked state, the aerosol generating device comprising:
a power supply configured to apply power to a component;
an aerosol generating unit configured to operate in the unlocked state and allow a cartridge, which is a consumable, to be mounted therein, and including a heater;
an authentication signal detecting unit configured to detect an authentication signal output from an external device;
an authentication signal processing unit configured to process the detected authentication signal; and
a controller configured to control an operation of the aerosol generating unit and switch a state into the locked state and the unlocked state,
wherein the controller is configured to switch the state of the aerosol generating device from the locked state to the unlocked state according to the authentication signal detected by the authentication signal detecting unit.

2. The aerosol generating device of claim 1, wherein the authentication signal detected by the authentication signal detecting unit includes at least one of a cartridge genuine authentication signal, a region authentication signal, and an age authentication signal.

3. The aerosol generating device of claim 2, wherein when results of all authentications included in the authentication signal detected by the authentication signal detecting unit are normal, the controller is configured to switch the state of the aerosol generating device from the locked state to the unlocked state.

4. The aerosol generating device of claim 1, wherein the authentication signal detected by the authentication signal detecting unit comprises any one of electromagnetic waves, sound waves, vibrations, and optical signals.

5. The aerosol generating device of claim 1, wherein the authentication signal detected by the authentication signal detecting unit comprises a control command for setting the aerosol generating unit to generate heat while following a predetermined heat generating mode.

6. The aerosol generating device of claim 1, wherein the authentication signal processing unit is configured to modulate the detected authentication signal in one or more of pulse modulation methods so that the controller recognizes the authentication signal.

7. The aerosol generating device of claim 1, wherein the controller is configured to switch the state of the aerosol generating device to the locked state when the cartridge mounted in the aerosol generating unit is removed in the unlocked state.

8. The aerosol generating device of claim 1, further comprising:
a puff sensor is configured to detect a puff action of a user of the aerosol generating device,
wherein the controller is configured to calculate a number of puffs based on the puff action detected by the puff sensor, and when the calculated number of puffs exceeds a predetermined threshold, the controller is configured to switch the aerosol generating device to the locked state.

9. An authentication system of an aerosol generating device using a signal, the authentication system comprising:
the aerosol generating device of claim 1; and
an authentication providing device comprising:
an authentication unit configured to perform at least one of genuine authentication of the cartridge mounted in the aerosol generating device, authentication of a region of a user of the aerosol generating device, and authentication of an age of the user;
an authentication signal generating unit configured to generate an authentication signal based on an authentication result of the authentication unit, and
authentication signal output unit configured to output the generated authentication signal to the outside.

10. The authentication system of claim 9, wherein the authentication signal generating unit is configured to modulate the authentication signal to be output by one or more of the pulse modulation methods so that the aerosol generating device recognizes the authentication signal.

11. The authentication system of claim 9, wherein the authentication unit is configured to perform genuine authentication by recognizing a QR code of the cartridge mounted in the aerosol generating device.

12. The authentication system of claim 9, wherein the authentication signal generated by the authentication signal generating unit comprises a control command for setting the aerosol generating unit to generate heat while following a predetermined heat generating mode.

13. The authentication system of claim 9, wherein the authentication signal output by the authentication signal output unit comprises any one of electromagnetic waves, sound waves, vibrations, and optical signals.
